(19) United States
(12) Patent Application Publication
(10) Pub. No.: US 2025/0196137 A1
(43) Pub. Date: Jun. 19, 2025

(54) PICO-WASHING: LIQUID EXCHANGE FOR CONTINUOUS-FLOW WASHING OF MICRODDROPLETS

(71) Applicant: THE TRUSTEES OF THE UNIVERSITY OF PENNSYLVANIA, Philadelphia, PA (US)

(72) Inventors: David Aaron ISSADORE, Philadelphia, PA (US); Michael John SIEDLIK, Philadelphia, PA (US)

(21) Appl. No.: 18/844,490

(22) PCT Filed: Mar. 9, 2023
(86) PCT No.: PCT/US2023/064009

§ 371 Date: Sep. 6, 2024

Related U.S. Application Data
(60) Provisional application No. 63/318,468, filed on Mar. 10, 2022.

(51) Int. Cl. B01L 3/00

(52) U.S. Cl. CPC B01L 3/502753; B01L 3/502715; B01L 2200/0621; B01L 2200/0652; B01L 2300/0645; B01L 2300/0874

(57) ABSTRACT

Droplet microfluidics is based on a toolbox of several established unit operations, including droplet generation, incubation, mixing, pico-injection, and sorting. In the last two decades, the development of droplet microfluidic systems, which incorporate these multiple unit operations into a workflow, have demonstrated unique capabilities in fields ranging from canalyses to materials optimization. One unit operation that is sorely underdeveloped in droplet microfluidics is washing, the exchange of the fluid in a droplet with a different fluid. Here, we demonstrate what we coin the “pico-washer.” a unit operation capable of simultaneously adding fluid to and removing fluid from droplets in flow while requiring only a small footprint on a microfluidic chip. We describe the fabrication strategy, device architecture, and process parameters required for stable operation of this technology capable of operating with kHz droplet throughput.

### CROSS REFERENCE TO RELATED APPLICATIONS

The present application claims priority to and the benefit of U.S. patent application No. 63/318,468, “Pico-Washing: Liquid Exchange For Continuous-Flow Washing Of Microdroplets” (filed Mar. 10, 2022). All foregoing applications are incorporated herein by reference in their entireties for any and all purposes.

### GOVERNMENT RIGHTS

This invention was made with government support under W81XWH-19-2-0002 awarded by the Medical Research and Development Command, and HG010023, CA206907, MH118170, AI147406, and EB023989 awarded by the National Institutes of Health. The government has certain rights in the invention.

### TECHNICAL FIELD

The present disclosure relates to the field of microfluidics and the field of microdroplet washing.

### BACKGROUND

Droplet microfluidic technology has rapidly developed in the last two decades and is now making a major impact across multiple domains of science and technology, including 1) transcriptomic^{1,2}, proteomic³, and genomic^{4,5} analysis at the single-cell⁶ and subcellular⁷ level, 2) ultra-high sensitivity clinical diagnostics^{8,9}, 3) high throughput screening for cellular phenotyping¹⁰⁻¹³, directed evolution¹⁴⁻¹⁶, and materials optimization¹⁷⁻¹⁹, and 4) the high-throughput production of monodisperse microparticles for pharmaceutical, cosmetic, and energy applications^{20,21}. Underlying these successes are several fundamental differences between assays carried out in droplets versus conventional, milliliter-scale laboratory apparatuses. By partitioning a fluidic sample into femtoliter-to-picoliter droplets, droplet microfluidics reduces biological and chemical reactions to the micrometer scale and enables the creation of many distinct reaction vessels that can be controlled or analyzed in parallel.

Due to the small size of these droplets, mass transport is enhanced with the reduced timescale of diffusion and because of the intra-droplet circulating flows that occur as a droplet moves through a microfluidic channel, an important feature for rapid biomolecular binding assays²² and the production of monodisperse nanoparticles²³. When a bulk solution is partitioned into sufficiently more droplets than there are copies of a target analyte, each droplet will likely contain either zero or one instance of the target. In this “digital” regime, droplet-based assays can perform absolute quantification with 1000× greater sensitivity and enhanced linearity compared to bulk assays^{24,25} and resolve single cells²⁶, organelles²⁷, extracellular vesicles^{28,29}, and virus particles³⁰, as well as individual molecules of nucleic acid^{31,32} and protein^{25,33}. Finally, by arranging droplet unit operations in series on a single chip, a chemical or biological protocol can be carried out automatically and with reduced losses due to manual fluid transfer, thereby reducing reagent cost and experimental time³⁴. The development of unit operations, such as droplet encapsulation, merging, splitting, and sorting³⁵, has fueled the development of integrated droplet workflows where multiple unit operations can be incorporated in series to produce the desired capability in an automated fashion or in parallel to enhance the number of droplets processed per unit time. Novel droplet unit operations amenable to operating in series and in parallel have the potential to unlock new assays while building upon the successes and harnessing the strengths of droplet microfluidics.

One unit operation that is sorely underdeveloped in droplet microfluidics is washing, i.e. the exchange of fluid through droplets during continuous flow, such as to remove chemical species or perform in-droplet sample preparation. Whereas other bench-scale biological and chemical processes have been successfully mimicked at the micro-scale, e.g. droplet generation miniaturizes partitioning a fluidic sample into tubes or wells and pico-injection miniaturizes the addition of fluid into existing fluidic compartments³⁹, it has proven challenging to create a unit operation that (1) miniaturizes the direct exchange of unwanted fluid with a new fluid, and (2) is capable of operating with throughputs demonstrated by other droplet operations, such as generation²⁰ and detection⁸. Accordingly, there is a long-felt need in the art for systems and methods for droplet washing.

### SUMMARY

In meeting the described long-felt needs, the present disclosure provides a fluidic system, comprising: a picowasher, the picowasher comprising: an primary channel, the primary channel being configured to communicate therein a continuous phase having a droplet comprising a dispersed phase therein; a wash channel; and a waste channel, the picowasher defining a junction between the primary channel, the wash channel, and the waste channel, at which junction the wash channel and the waste channel enter the waste channel opposite one another, and the picowasher being configured to communicate a wash fluid through the wash channel to the junction such that wash fluid displaces at least some of the dispersed phase from the droplet, at least some of the wash fluid being retained within the droplet and the at least some dispersed phase being communicated to the waste channel.

Also provided is a method, comprising operating a fluidic system according to the present disclosure (e.g., according to any one of Aspects 1-12) so as to communicate a wash fluid through the wash channel to the junction such that wash fluid displaces at least some of the dispersed phase from the droplet, at least some of the wash fluid being retained within the droplet and the at least some dispersed phase being communicated to the waste channel.

Further disclosed is a method, comprising: communicating a microdroplet in an primary channel to a first picowasher that comprises a first junction between the primary channel, a first wash channel, and a first waste channel, the microdroplet comprising a dispersed phase therein, the first wash channel and first waste channel opposing one another at the junction, communicating a wash fluid through the first wash channel to the junction such that wash fluid displaces at least some of the dispersed phase from the droplet, at least some of the wash fluid being retained within the droplet and the at least some dispersed phase being communicated to the first waste channel.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1: Overview of the pico-washer concept and device. (a) Schematic of the droplet washing strategy described here. (b) Photograph of the microfluidic device with fluidic and electrical connections in place. Pressure notations next to each fluidic input correspond the streams depicted in (a). All fluidic channels and tubing are filled with dye for ease of visualization. Note that the outlet from the wash stream is clamped during operation to direct all fluid through the pico-washer. The scale bar represents 1 cm. (c) Schematic of the droplet generator and pico-washer (highlighted in red) arranged in series in a single microfluidic device. (d) Micrographs of an initially dye-laden droplet (i) contacting, (ii) fully connected to, and (iii) disassociating from a pico-washer. Scale bars represent 50 □m.

FIG. 2: Fabrication of the pico-washer microfluidic device. (a) Micrograph depicting top-down view of the PDMS microfluidic device. The inset shows a magnified view of the fluid transfer region. (b) Micrograph depicting the cross section of a PDMS device along the dashed yellow line marked in (a). (c) Schematic of the fabrication strategy for making the microfluidic devices. (i) First, an entirely PDMS device is constructed by aligning and plasma bonding two lithographically defined pieces of PDMS. Then, (ii) the waste channel is rendered hydrophilic and (iii) the emulsion channel is rendered hydrophobic. All scale bars represent 50 μm.

FIG. 3: 3D interfacial pinning and spatial patterning of surface hydrophobicity are required for stable device operation. (a, i) Cross-sectional schematic and (a, ii) micrograph of an in-use microfluidic device that was created by bonding PDMS to a glass microscope slide. (b, i) Cross-sectional schematic and (b, ii) micrograph of an in-use, entirely PDMS microfluidic device engineered to have 3D interfacial pinning and rendered entirely hydrophobic. (c, i) Cross-sectional schematic and (c, ii) micrograph of an in-use, entirely PDMS microfluidic device engineered to have 3D interfacial pinning and spatially patterned surface hydrophobicity. False color is added to all micrographs for visualization of aqueous (yellow) and oil (magenta) phases and each micrograph depicts device operation without any applied electric field. The coordinate system corresponds to that used in FIG. 2: x and y represent the in-plane dimensions parallel and perpendicular, respectively, to the length of the channel. (d) Summary table describing the features and outcome of each fabrication strategy. All scale bars represent 50 μm.

FIG. 4: Pico-washer performance depends on the wash and waste stream fluidic pressures. (a) Transmitted light micrograph of a pico-washer device in operation. (b) Fluorescence micrograph of dye initially present within the droplets. (c) Fluorescence micrograph of dye added to droplets during the washing process. (a)-(c) all correspond to the same device. The black dashed box in (a) represents the region depicted in (b) and (c). (d) Plot of washing efficiency as a function of input pressures to the wash (P_{H}) and waste (P_{L}) streams when P_{C}=28 kPa and P_{D}=24 kPa. The color of each data circle indicates the washing efficiency when the device was operated with those input pressures. Regions highlighted by (i), (ii), or (iii) correspond to those depicted in (e). (e) Micrographs depicting failure modes that arise when the fluidic pressures are imbalanced: (i) the wash stream pressure is too low; (ii) the wash stream pressure is too high; and (iii) the waste stream pressure is too low. False coloring is added for visualization of wash (green), dispersed (yellow), oil (magenta), and waste (red) streams. All scale bars represent 50 □m.

FIG. 5: Washing efficiency depends on the geometry of the fluid transfer region. (a, i) Side-profile schematic, (a, ii) top-down transmitted light micrograph, and (a, iii) top-down fluorescence micrograph of droplets, initially laden with FITC, flowing through a device with a horizontal fluid transfer region. In this device, the width of the aperture is greater than the height. (b, i) Side-profile schematic, (b, ii) top-down transmitted light micrograph, and (b, iii) top-down fluorescence micrograph of droplets, initially laden with FITC, flowing through a device with a vertical fluid transfer region. In this device, the height of the aperture is greater than the width. Yellow boxes in (a, i) and (b, i) represent the side profile of the fluid transfer region in the respective devices. All scale bars represent 50 m. (c) Washing efficiency, quantified from fluorescence images as in (a-b, iii), for each of the device geometries represented in (a)-(b). Error bars represent the standard deviations determined from n=4 independent devices constructed with each of the designs depicted in (a) and (b). *p 0.05, Mann-Whitney U test.

FIG. 6: Quantitative visualization of the pico-washer in operation. (a) Transmitted light micrographs of droplets initially laden with dye. Micrographs (i)-(v) represent droplets at different stages of the washing process. Scale bars represent 50 □m. (b) Heat maps depicting z-averaged, intra-droplet dye concentrations overlaid with the outline of the respective droplet (white dashed line). Plots (i)-(v) correspond to the droplets depicted in (a). Scale bars represent 10 μm. Note that regions of the droplet closest to the top and bottom walls of the PDMS microchannel were not analyzed to prevent optical aberrations, due to the device fabrication process, from skewing the quantitative mapping seen in (B).

FIG. 7: Design rule for operating multiple pico-washers in series. (a) Micrograph of a device with multiple pico-washers arranged in series and labeled with key fluidic resistances: the resistance of the washing process (R_{wash}), with components representing the pico-injector (R_{inject}) and the removal process (Rᵣₑₘₒᵥₑ); the resistance of the high-pressure wash stream between adjacent pico-washers (R_{H}); and the resistance of the low-pressure waste stream between adjacent pico-washers (R_{L}). (b) Circuit diagram representing the system for two pico-washers arranged in series. (c) Micrographs of droplets (initially laden with dye) in devices with multiple pico-washers where the design rule is not satisfied. (d) Micrographs of droplets (initially laden with dye) in devices with pico-washers where the design rule is satisfied. All scale bars represent 50 μm.

FIG. 8: Dye is removed from and added to droplets during pico-washer operation. (a, i) Transmitted light micrograph of collected droplets, (a, ii) fluorescence micrograph of dye initially contained within the droplets, and (a, iii) fluorescence micrograph of dye initially contained in the wash stream when the saltwater electrode is not activated and pico-washing does not occur. (b, i) Transmitted light micrograph of collected droplets, (b, ii) fluorescence micrograph of dye initially contained with the droplets, and (b, iii) fluorescence micrograph of dye initially contained in the wash stream following pico-washing. (c) Histogram of mean gray values (CV=4.4%; N=100 droplets) contained within the droplets imaged in (b, ii). (d) Histogram of mean gray values (CV=3.9%; N=100 droplets) contained within the droplets represented in (b, iii). All scale bars represent 50 μm.

FIG. 9: Droplet sizes are highly uniform prior to and following pico-washing. (a) Transmitted light image of droplets traversing a pico-washer in the device represented in FIG. 4. (b) Histogram of plug lengths of fully formed droplets upstream of the pico-washer (CV=0.8%; N=31 droplets). (c) Histogram of droplet plug lengths immediately downstream of the pico-washer (CV=0.7%; N=54 droplets). Scale bar represents 50 μm.

FIG. 10: Washing efficiency is calculated from a long-exposure fluorescence image of the device in operation, a control image of the droplets without the application of the saltwater electrode, and a background image. (a) Fluorescence micrograph of dye initially contained within the droplets during pico-washer operation. The white, dashed line provides a reference outline of the channels. This image is comparable to FIG. 4b. (b) Fluorescence micrograph of device in operation without the application of the saltwater electrode. In this case, there is no fluid transfer. (c) Fluorescence micrograph of the background signal arising from the optical setup and PDMS device. (d) Plot depicting the integrated channel intensity profiles, I_{wash}, I_{cntl}, and I_{back}, corresponding to the images depicted in (a), (b), and (c), respectively. (e) Normalized intensity profile along the length of the channel. Regions 1 and 2 correspond to the normalized intensities before and after the pico-washer, respectively. (f) Transmitted light image highlighting the lengths used to correct for small changes in droplet length in the calculation of the dilution factor. All scale bars represent 50 μm.

FIG. 11: Pico-washing produces a narrow distribution of droplet sizes for sufficiently high AC field frequencies. Histograms depicting distributions of droplet sizes in an example experiment after pico-washing for applied AC field frequencies of (a) 200 kHz, (b) 20 kHz, (c) 2 kHz, and (d) 0.2 kHz.

FIG. 12: An AC field provided by the saltwater electrode was necessary for reproducible device operation. (a) Fluorescence micrograph of dye initially contained within the droplets during pico-washer operation. (b) Fluorescence micrograph of dye initially contained within the droplets during pico-washer operation, with the polarity of the field reversed relative to (a). Note the diminished dye signal in the waste stream relative to (a). (c) Plot of the calculated dilution factor for individual devices without and with reversing the polarity of the DC field. Each data point represents one device in operation: the x value represents the dilution factor calculated when the device was set up in a configuration with the positive terminal connected to the wash stream; the y value represents the dilution factor calculated in the same device after the polarity of the DC field was reversed. All scale bars represent 50 μm.

FIG. 13: Image processing workflow to visualize droplet motion with microsecond resolution. (a) Process schematic of image processing workflow. (b) Three representative transmitted light images of the device in operation. (c) Segmented images highlighting the reference droplet (yellow) obtained by intensity-based thresholding of the corresponding images in (b). (d) Representative transmitted light images used to determine the reference droplet position by comparing an image of a known droplet. (i) Transmitted light image of the channel region immediately upstream of a pico-washer. (ii) Three example cropped regions of (i), each corresponding to a different sub-image of the channel. (iii) A reference image of a droplet. (e) Plot depicting the sum-square difference between pixel values in the reference image (d, iii) and each sub-image formed by cropping the channel at progressively downstream channel positions. The circles highlight values for the three sub-images represented in (d, ii). (f) Plot of the x positions of the reference droplets in the reordered image sequence of a 1,000-frame video. All scale bars represent 50 μm.

FIG. 14: Image processing workflow to quantify local z-averaged dye concentrations with microsecond and micrometer resolution during pico-washing. (a) Process schematic of image processing workflow. (b) Short exposure images representing the formation of droplets with known dilutions of dye and the flow of these droplets through the device without pico-washing. (c) Reference images obtained by averaging intra-droplet gray values present at each pixel location. (d) Boxplots representing the distribution of droplets averaged by pixel for each known dilution. (e) Representative overlay of data points (black) with a linear model (red) of gray values vs. known dye concentrations for one pixel location. (f) Distribution of coefficients of determination for all pixel locations. All scale bars represent 50 μm.

FIG. 15: Arranging two pico-washers in series compounds the washing performance of each pico-washer. (a) Transmitted light micrograph of two pico-washers arranged in series. (b) Fluorescence micrograph of dye initially present within the droplets. (c) Fluorescence micrograph of dye added to droplets during the washing process. (a)-(c) all correspond to the same device. The black dashed box in (a) represents the region depicted in (b) and (c). (d) Bar plot representing the dilution factor calculated after the first pico-washer and the dilution factor calculated after the two pico-washers arranged in series. All scale bars represent 50 μm.

FIG. 16: Pico-washer performance with droplets containing microparticles. (a) Transmitted light micrograph of droplets containing 8 μm polystyrene microparticles transiting a pico-washer. (b) Transmitted light micrograph of droplets containing 16 μm non-magnetic polymethylmethacrylate microparticles transiting a pico-washer. Inset depicts a microsphere lodged in the fluid transfer aperture between the emulsion channel and waste stream. (c) Schematic of the experimental setup used to test the retention of 8 μm paramagnetic polystyrene microparticles in droplets during pico-washing. (d) Transmitted light micrograph of two pico-washers arranged in series. (e) Fluorescence micrograph of dye initially present within the droplets. (f) Bar plot depicting the retention of 8 μm paramagnetic polystyrene microparticles in droplets for two washing performances. (d) and (e) correspond to the device represented by the bottom bar in (f). All scale bars represent 50 μm, except for the scale bar representing 10 μm in the inset of (b).

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

Droplet microfluidic technology has rapidly developed in the last two decades and is now making a major impact across multiple domains of science and technology, including 1) transcriptomic^{1,2}, proteomic³, and genomic^{4,5} analysis at the single-cell⁶ and subcellular⁷ level, 2) ultra-high sensitivity clinical diagnostics^{8,9}, 3) high throughput screening for cellular phenotyping¹⁰⁻¹³, directed evolution¹⁴⁻¹⁶, and materials optimization¹⁷⁻¹⁹, and 4) the high-throughput production of monodisperse microparticles for pharmaceutical, cosmetic, and energy applications^{20,21}. Underlying these successes are several fundamental differences between assays carried out in droplets versus conventional, milliliter-scale laboratory apparatuses.

By partitioning a fluidic sample into femtoliter-to-picoliter droplets, droplet microfluidics reduces biological and chemical reactions to the micrometer scale and enables the creation of many distinct reaction vessels that can be controlled or analyzed in parallel. Due to the small size of these droplets, mass transport is enhanced with the reduced timescale of diffusion and because of the intra-droplet circulating flows that occur as a droplet moves through a microfluidic channel, an important feature for rapid biomolecular binding assays²² and the production of monodisperse nanoparticles²³. When a bulk solution is partitioned into sufficiently more droplets than there are copies of a target analyte, each droplet will likely contain either zero or one instance of the target. In this “digital” regime, droplet-based assays can perform absolute quantification with 1000× greater sensitivity and enhanced linearity compared to bulk assays^{24,25} and resolve single cells²⁶, organelles²⁷, extracellular vesicles^{28,29}, and virus particles³⁰, as well as individual molecules of nucleic acid^{31,32} and protein^{25,33}. Finally, by arranging droplet unit operations in series on a single chip, a chemical or biological protocol can be carried out automatically and with reduced losses due to manual fluid transfer, thereby reducing reagent cost and experimental time³⁴.

The development of unit operations, such as droplet encapsulation, merging, splitting, and sorting³⁵, has fueled the development of integrated droplet workflows where multiple unit operations can be incorporated in series to produce the desired capability in an automated fashion or in parallel to enhance the number of droplets processed per unit time. Novel droplet unit operations amenable to operating in series and in parallel have the potential to unlock new assays while building upon the successes and harnessing the strengths of droplet microfluidics.

One unit operation that is sorely underdeveloped in droplet microfluidics is washing, i.e. the exchange of fluid through droplets during continuous flow, such as to remove chemical species or perform in-droplet sample preparation³⁶⁻³⁸ Whereas other bench-scale biological and chemical processes have been successfully mimicked at the micro-scale, e.g. droplet generation miniaturizes partitioning a fluidic sample into tubes or wells and pico-injection miniaturizes the addition of fluid into existing fluidic compartments³⁹, it has proven challenging to create a unit operation that 1) miniaturizes the direct exchange of unwanted fluid with a new fluid, and 2) is capable of operating with throughputs demonstrated by other droplet operations, such as generation²⁰ and detection⁸.

Existing washing technologies can suffer from large footprints or the requirement to synchronize multiple droplets and streams. As a result, it is nontrivial, and potentially not feasible, to operate microfluidic chips with these operations arranged in series or in parallel, thereby imposing a challenging limitation on improving washing performance and achieving the >kHz benchmark typical in other droplet operations^{8,20,35}.

The long-felt need for improved droplet washing is well-known and has been articulated by those in the field, who have identified the shortcomings in other approaches:

“For example, some biological assays require washing steps, in which reagents from a first reaction must be completely removed before a new set of reagents is introduced. Such heterogeneous assays are difficult to perform inside droplets. Droplet contents can be adjusted through droplet fusion or by injecting a liquid stream; however, these procedures do not completely exchange a buffer.” “Single-cell analysis and sorting using droplet-based microfluidics,” Nature Protocols, volume 8, pages 870-891 (2013).

“Nevertheless droplets suffer from to the difficulty to vary their content in time or to track the evolution within an individual droplet. This has limited their application to the simple demonstration non-viral transfection.” “Tracking the Evolution of Transiently Transfected Individual Cells in a Microfluidic Platform,” Scientific Reports, volume 8, Article number: 1225 (2018).

“Second, although merging droplets together allows the addition of solutions into a pre-formed droplet, removing chemical species from droplets is not generally possible. As such, transient transfection protocols cannot be performed in traditional droplet microfluidics.” “Tracking the Evolution of Transiently Transfected Individual Cells in a Microfluidic Platform,” Scientific Reports, volume 8, Article number: 1225 (2018).

“Droplet microfluidics has shown great potential for on-chip biological and chemical assays. However, fluid exchange in droplet microfluidics with high particle recovery is still a major bottleneck.” “On-chip background dilution in droplets with high particle recovery using acoustophoresis,” Biomicrofluidics 13, 064123 (2019).

“Despite the numerous advantages and potential applications of droplet microfluidics, a major limitation has been the lack of robust integration with solid-phase techniques. If these devices are to be successfully applied to solve many biochemical problems, the bottleneck of manual sample cleanup and extraction must be addressed.” “Active Flow Control and Dynamic Analysis in Droplet Microfluidics,” Annual Review of Analytical Chemistry, volume 14, 2021 Shi, pp 133-153.

“Additive functions such as generation and injection are commonplace, however subtractive functions such as washing are less established, especially in a robust manner at high throughput,” Micro and Nano Systems Letters, volume 6, Article number: 3 (2018).

To address these challenges, we have developed a new approach to droplet washing that is capable of simultaneously adding and removing fluid from droplets with kHz throughput and that can be robustly incorporated with other unit operations, such as droplet generators and other droplet washers. We term this unit operation a “pico-washer” and demonstrate the device architecture required for stable performance. Several key features were necessary to overcome previously unsolved challenges and develop the pico-washer: 1) a fabrication strategy combining interfacial pinning and spatial patterning of channel hydrophilicity to stabilize the coflow of adjacent, immiscible phases, 2) an electric field to trigger the destabilization of the water-oil-water interfaces and form a fluidic connection between the passing droplets and the pico-washer, and 3) the incorporation of in-line flow resistors to allow uniform operation of multiple pico-washers arranged in series. Additionally, we define the process and geometrical parameters that dictate washing, create an image processing workflow to characterize the washing process with microsecond-scale and micrometer-scale resolution, and highlight the engineering design rule required for operating multiple pico-washers in series on a single chip. By introducing and characterizing this much-needed unit operation to the droplet microfluidic toolbox, we anticipate this device will provide a foundation for future development of integrated, multi-step droplet workflows.

### Results

### Pico-Washer Architecture

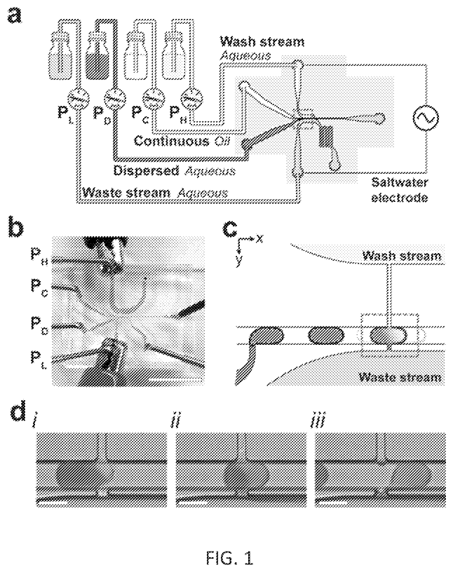

To develop and evaluate the droplet washing technology, we designed a four-input, pressure-driven microfluidic system that integrated a T-junction droplet generator with a region that we term a “pico-washer” (FIG. 1a-c). Two of these fluidic inputs provided the aqueous dispersed phase and oil continuous phase to the T-junction, which was designed to produce 75 μm diameter water-in-oil (W/O) droplets at a volume fraction of approximately 0.5. Downstream of the T-junction droplet generator, droplets flowed in plug-flow in a channel that was 50 μm wide and 60±5 μm high. Further downstream was the pico-washer, which consisted of two lithographically defined channels arranged perpendicularly to, and on either side of, the emulsion channel. One channel, 500 μm long by 15 μm wide by 50 μm high, connected the emulsion channel with a high-pressure (“wash”) aqueous stream. The other channel, 15 μm long by 15 μm wide by 50 μm high, connected the emulsion channel with a low-pressure (“waste”) aqueous stream.

It should be understood that although the figures and certain illustrative examples herein refer to an emulsion channel, the disclosed technology is not limited to use with emulsions, and the illustration of the disclosed technology in connection with emulsions is illustrative only and not limiting of the scope, use, or application of the technology. As some non-limiting examples, the disclosed technology can be used, e.g., to exchange fluid in a multi-order emulsion (e.g., a double emulsion), in a hydrogel, or in other applications.

We designed the pico-washer so that as a moving W/O droplet made fluidic contact with the two channels of the pico-washer, one at a higher pressure and one at a lower pressure relative to the droplet, fluid would be transferred through the droplet. This was first evaluated qualitatively in the washing of droplets initially laden with food coloring dye (FIG. 1d). Each droplet, generated by the upstream T-junction, transited the pico-washer and underwent the following operation: 1) the moving droplet made fluidic contact with the wash and waste streams (FIG. 1d, i); 2) the concentration of dye in the droplet was visibly reduced with the continued addition of clear PBS solution and removal of dye solution (FIG. 1d, ii); 3) the droplet disconnected from the pico-washer after approximately 0.5 ms of washing and continued flowing through the emulsion channel (FIG. 1d, iii). In these experiments, fluidic connection between the pico-washer and droplets was enabled by an AC voltage (100 Vₚₚ at 100 kHz) delivered via a saltwater electrode through the aqueous wash and waste streams and applied across the 50 μm emulsion channel width.

### Pico-Washer Design: Interfacial Pinning and Spatial Patterning of Channel Hydrophilicity

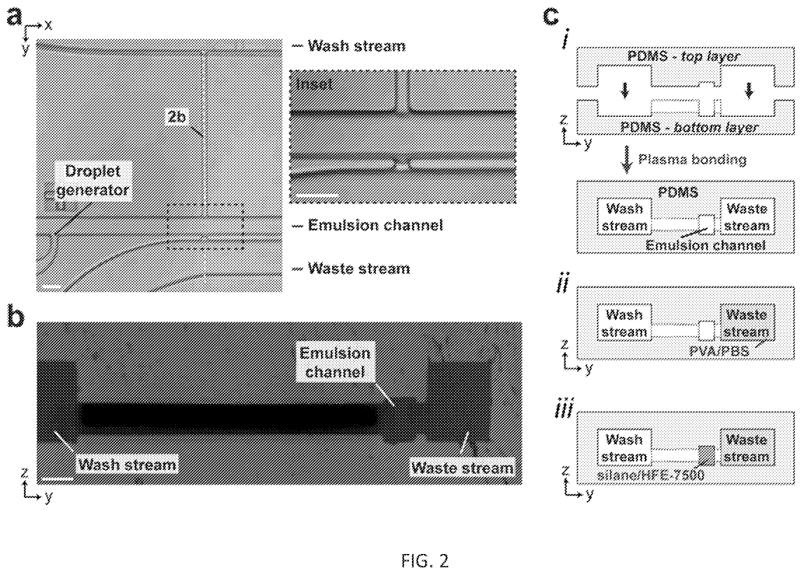

To realize pico-washer operation experimentally, microfluidic devices were developed and constructed entirely out of polydimethylsiloxane (PDMS) in a multi-step process that combined soft lithography and spatial patterning of channel hydrophilicity (FIG. 2). First, microfluidic channels for all fluidic streams were lithographically defined in PDMS (FIG. 2a). Next, a fabrication strategy was developed in which two pieces of PDMS, one for the top of the microfluidic device and the other piece for the bottom of the device, were aligned and irreversibly plasma bonded to create a device architecture in which the wash, emulsion, and waste streams were taller than the perpendicular channels in the pico-washer that connected these streams (FIG. 2b). The intent of this height difference was to introduce a “step” that would promote pinning of the oil-water interface between the continuous phase and waste stream in the z-direction, similar to that used to stabilize interfaces in the xy plane in other microfluidic systems⁴⁷. Following PDMS device assembly, the waste and emulsion channels were rendered hydrophilic and hydrophobic, respectively, to further promote oil-water interfacial stability (FIG. 2c).

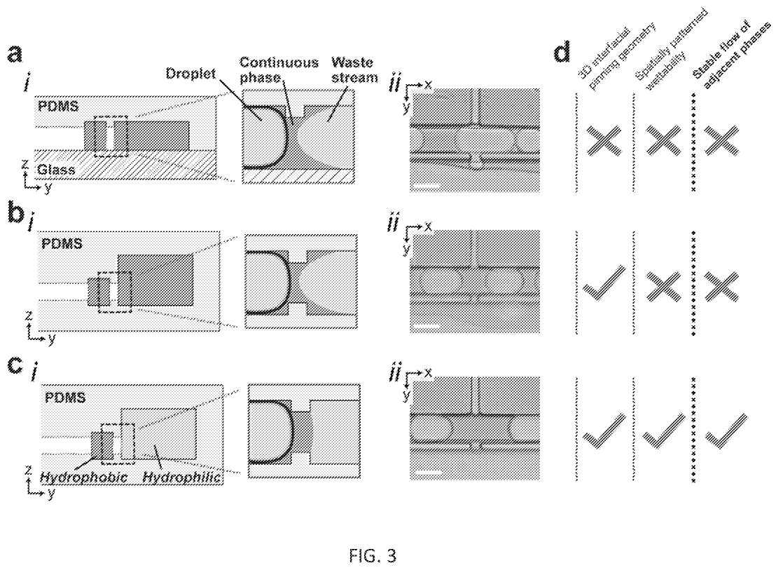

Both the interfacial pinning and the spatial patterning of surface hydrophilicity were required for stable flow of the W/O emulsion adjacent to the aqueous wash and waste streams contained within the pico-washer. A common mode of failure for microfluidic devices that include multi-phasic flows of immiscible liquids is the destabilization of the interface between the phases. When the pico-washer did not include interfacial pinning or patterned hydrophilicity, this destabilization would lead to the loss of oil from the emulsion channel to the waste channel. When this loss of continuous phase occurred, the distance between droplets decreased, leading to two undesirable outcomes: unstable device operation and the merging of successive droplets. This was observed in devices created by “standard” microfluidics soft lithography, in which one lithographically defined piece of PDMS was bonded to a glass slide and the entire device was made hydrophobic (FIG. 3a, i), as well as in devices with channel geometries that promoted interfacial pinning but without patterned hydrophilicity (FIG. 3b, i). In both cases, oil would wet the adjacent waste channel, resulting in the loss of continuous phase from the emulsion channel (FIG. 3b, ii and c, ii). However, when the waste and emulsion channels were made hydrophilic and hydrophobic (FIG. 3c, i), respectively, the oil phase was confined to the emulsion channel during device operation (FIG. 3c, ii). The result of these design iterations was a microfluidic system in which a stream of W/O droplets could stably flow adjacent to the aqueous channels contained within the pico-washer (FIG. 3d).

### Visualization and Quantification of Pico-Washer Performance

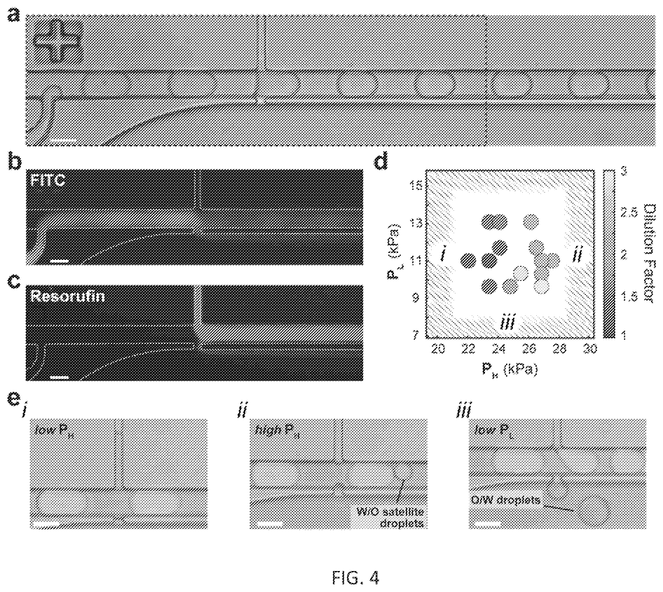

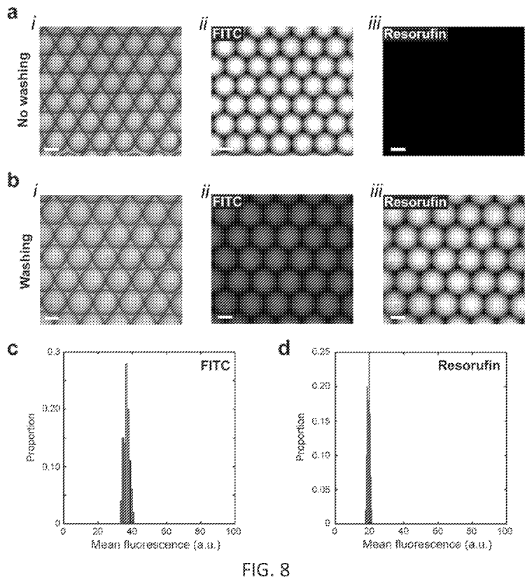

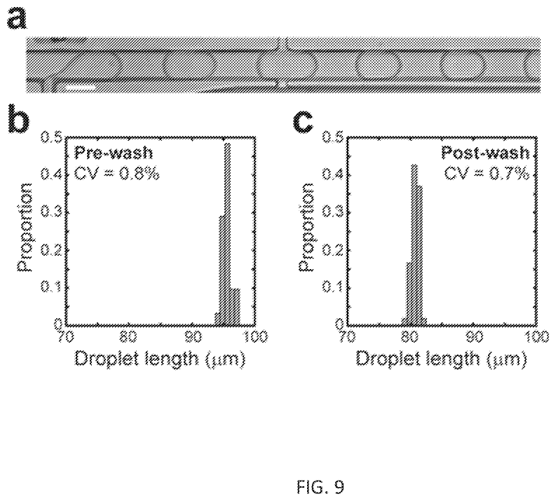

To visualize and quantify fluid transfer through the droplets, separate fluorescent dyes were incorporated into the dispersed phase and wash stream and simultaneously imaged during device operation (FIG. 4a-c). By capturing long exposure (>400 ms) images, such that the measured fluorescence signal from dye-laden droplets appeared as a streak in the emulsion channel, the removal and addition of dye could be directly observed. In these experiments, the measured signal from FITC dye, initially present in the dispersed phase, diminished at the site of the pico-washer (FIG. 4b). In the emulsion channel, the decrease in the measured fluorescence of FITC corresponded with an increase in the fluorescence signal of resorufin, the dye present in the wash stream (FIG. 4c). Imaging washed droplets off-chip confirmed that the resorufin solution was directly added to the flowing droplets and not lost to the continuous phase (FIG. 8a, b). Furthermore, quantifying the mean gray values in these droplets indicated that comparable amounts of dye were removed (CV=4.4%) and added (CV=3.9%) across all droplets (N=100). Devices demonstrated a throughput of >1.0 kHz for pico-washing, where the input pressures for the continuous and dispersed phases were kept below 35 kPa to prevent the upstream droplet generator from operating in the jetting regime and to minimize polydispersity in the droplets entering the pico-washer. Under these operating conditions, as seen in FIG. 4a, uniform droplet sizes were observed both upstream (CV=0.8%) and downstream (CV=0.7%) of the pico-washer (FIG. 9).

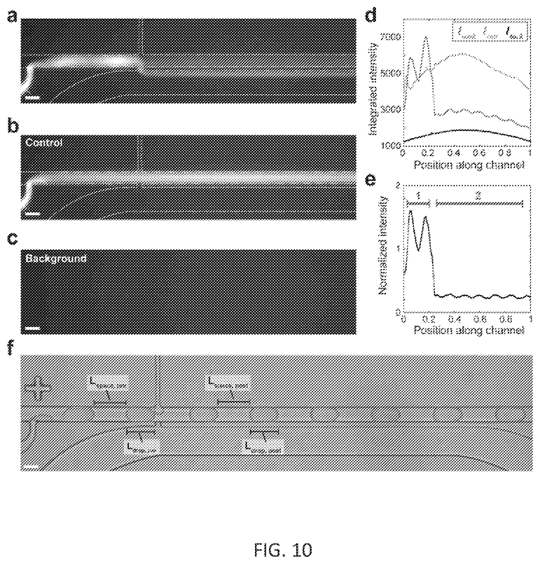

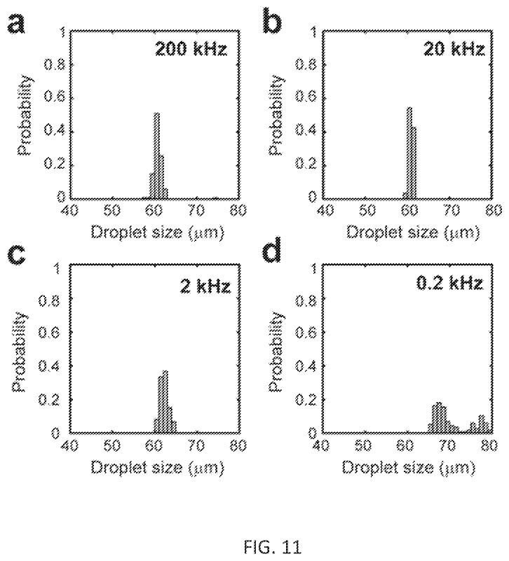

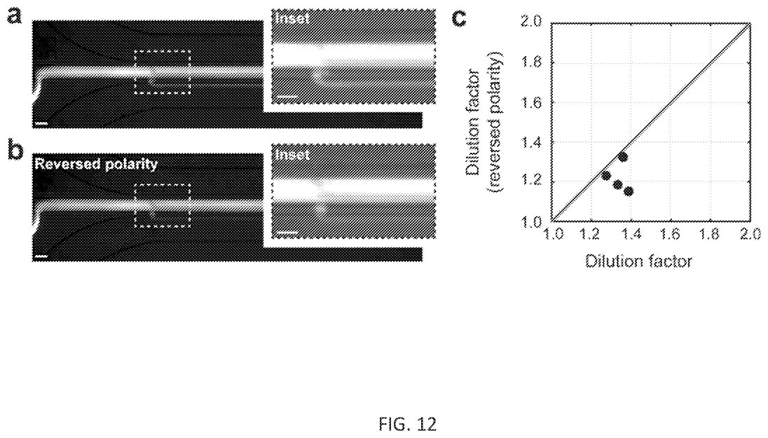

Stable pico-washer operation was typified by a fluidic bridge connecting the wash and waste streams with a W/O droplet (FIG. 4a). Formation of this fluidic bridge required the destabilization of the oil-water interfaces with an AC electric field applied to the pico-washing region: pico-washing did not occur when the field was not applied (FIG. 10a, b). This field was applied via a saltwater electrode⁴⁸ in which the output terminals from a power source were connected with alligator clips to stainless steel inlets of the waste and wash channels. As concentrated PBS was used in the wash and waste streams, the conductivity of these solutions enabled efficient charge transfer and the AC electric field to be applied across the pico-washer. The AC field oscillation frequency was chosen while considering the time scale that a droplet was connected to the pico-washer, which was estimated as the time required for a droplet to move one droplet length, i.e. from first connecting (FIG. 1d, i) to dissociating (FIG. 1d, iii) from the pico-washer. For typical experimental parameters (emulsion flow rates of 2 mL/hr, droplets generated as 85 μm long plugs, and a total channel height and width maintained at 60 μm and 50 μm, respectively), the time scale of pico-washing was approximately 0.5 ms. When the AC field was applied at frequencies greater than 1/0.5 ms=2 kHz, to ensure that each droplet experienced a sufficiently high field magnitude and made fluidic contact upon approaching the pico-washer, steady and reproducible fluid exchange was observed (FIG. 11). Applying an AC field was critical in these experiments, as the use of a DC field resulted in irreproducible dye removal and droplet washing (FIG. 12).

### Operational and Geometrical Parameters Regulate Pico-Washer Performance

We investigated the parameter space governing the operation of a pico-washer and observed that the pressure difference between the wash and waste streams regulated the performance of pico-washing. To perform this analysis, we systematically varied the input pressures of the wash and waste streams of a given device while maintaining the input pressures of the continuous and dispersed phases. The dilution factor, defined as the fold change by which the concentration of moieties originally contained within the droplet was reduced during the washing process (see Materials and Methods), was used to quantify washing performance for each set of parameters. In these experiments, we observed that increasing the input pressure to the wash stream and decreasing the input pressure to waste stream resulted in increased dilution factors (FIG. 4d). The greatest dilution factor was observed at the largest wash pressure and smallest waste pressure, an observation consistent with the pressure difference driving fluid transfer through the droplets. It is noteworthy that the wash and waste stream input pressures could only be varied within an acceptable range (FIG. 4e): overly decreasing the wash stream pressure resulted in oil entering the injection channels (FIG. 4e, i), thereby preventing fluid transfer; overly increasing the wash stream pressure resulted in W/O droplets forming in the emulsion channel (FIG. 4e, ii); and overly decreasing the waste stream pressure resulted in oil-in-water (O/W) droplets forming in the waste stream (FIG. 4e, iii).

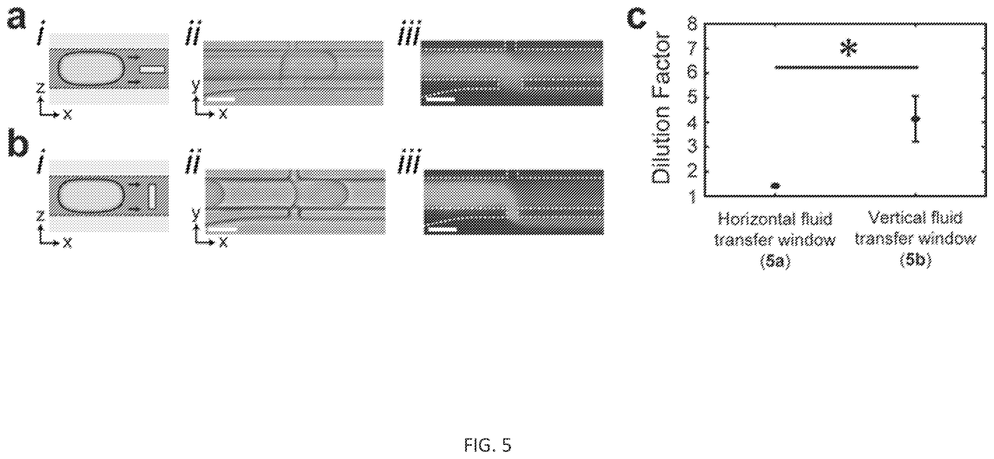

We next investigated how the geometry of the pico-washer architecture affected washing performance by evaluating how the orientation of the fluid transfer channels influenced the measured dilution factors. To investigate this, we created pico-washers with “horizontal” fluid transfer channels (FIG. 5a, i and ii), in which the height of a channel was less than its width, as well as pico-washers with “vertical” fluid transfer channels (FIG. 5b, i and ii), characterized by a height of the channel greater than the width. In both cases, at least one dimension was kept less than 15 μm to ensure a sufficiently high Laplace pressure to immobilize the fluid interfaces in the presence of the applied pressure differential between adjacent streams. When each of these devices was operated with input pressures tuned for optimal fluid exchange, less dye removal was observed in the case of the horizontal fluid transfer region (FIG. 5a, iii) compared to the vertical case (FIG. 5b, iii). Quantitative analysis of these data revealed that the vertical pico-washer demonstrated a typical dilution factor of 4, while pico-washers with horizontal fluid transfer channels demonstrated a dilution factor of 1-1.5 (FIG. 5c).

### Quantitatively Evaluating Pico-Washing on the Sub-Droplet Level

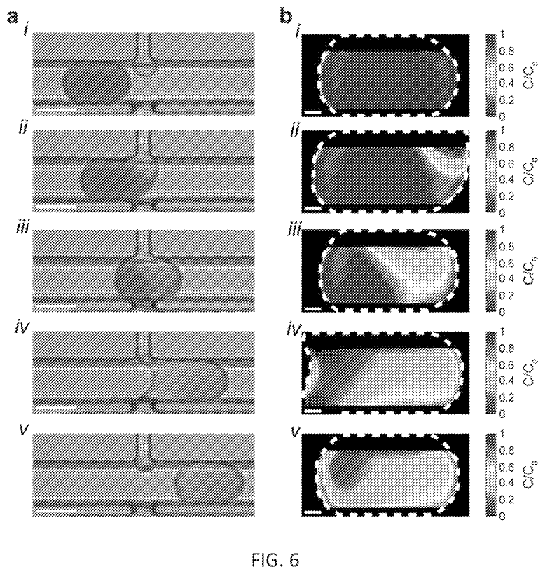

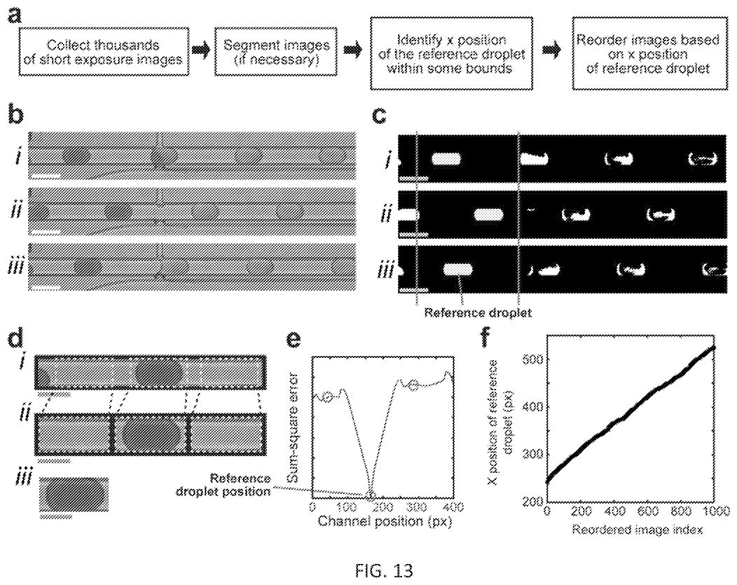

To aid in visualizing the pico-washing process, we developed an image processing workflow inspired by optically gated heart imaging⁴⁹ to reconstruct videos of droplet motion with microsecond resolution. This algorithm was based on collecting many short exposure (<10 ms) images, where each image represented a random sampling of the position of droplets in the channel (FIG. 13). The key aspect of this workflow was to identify the position of one reference dye-laden droplet for each frame post-acquisition (FIG. 13c-e) and sort the sequence of captured frames by this reference position to create an upsampled representation of a single droplet undergoing pico-washing. A representative reconstructed video depicted the operation of a pico-washer (Video 8). In this video, a droplet initially laden with dye appeared to move left-to-right towards the pico-washer and initially contacted the injection channel at the top-right portion of the droplet (FIG. 6a, i and ii). The droplet then made contact with the removal channel and dye was removed as the droplet progressed through the pico-washer (FIG. 6a, iii). Finally, the droplet broke off from the pico-washer and continued along the channel (FIG. 6a, iv and v). This reconstructed video, with 400 frames linearly distributed over the 0.5 ms pico-washing duration (FIG. 13f), depicted pico-washing with microsecond-scale resolution.

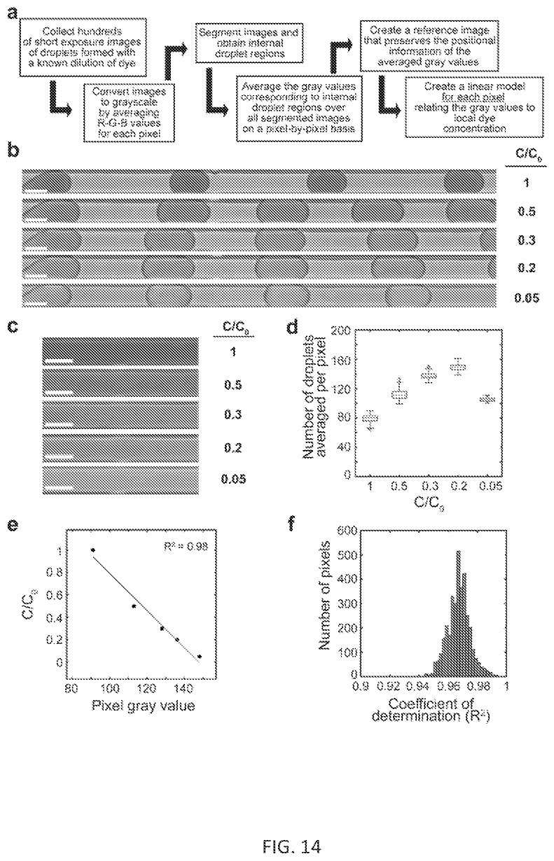

Using the reconstructed videos, we developed an additional image processing algorithm to quantitatively assess changes in dye concentration within the droplet during pico-washing (FIG. 14). In the videos, each measured intra-droplet gray value was assumed to represent the z-averaged local dilution of dye at that location. Next, we collected images of droplets with known dilutions of dye in the absence of pico-washing (FIG. 14b) and created pixel-by-pixel linear models relating gray values to local dilutions of dye (FIG. 14e, f). This collection of models was then used to determine the local dye dilution, analogous to applying the Beer-Lambert law, for each pixel in each video frame. A representative video depicted this quantitative analysis of a droplet undergoing pico-washing (Video 9). Initially, the droplet was entirely red, consistent with no washing (FIG. 6b, i). After the droplet contacted the pico-washer (FIG. 6b, ii), internal regions of the droplet became progressively bluer as the droplet proceeded through the pico-washer (FIG. 6b, iii and iv). As the droplet completed pico-washing, a highly blue region at the end of the droplet was observed, indicating a spatial dependence of washing efficiency on the sub-droplet level (FIG. 6b, v). Integrating the internal pixel values in a map corresponding to the conclusion of pico-washing in this video yielded an overall dilution factor of 3, comparable to the dilution factors obtained via long exposure imaging (FIG. 5c).

### Operating Pico-Washers in Series

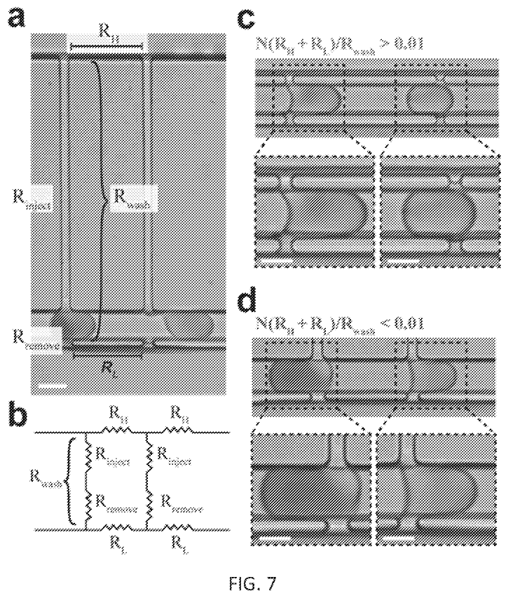

We next evaluated the feasibility of operating multiple pico-washers in series, an advantage made possible by the small footprint of each pico-washer. To create such a system, we formulated and applied a design rule to inform the selection of channel dimensions and spacing of the pico-washers. In a similar microfluidic system, the operation of many droplet generators in parallel, the fluidic resistance of the channel that connects adjacent droplet generators should be much less than the fluidic resistance within each generator to ensure uniform flow through the device⁵⁰. We reasoned that a similar relationship was important here, where we expected that the electrical and fluidic resistances in the waste and wash streams between adjacent pico-washers should be much less than the resistances within a given pico-washer (FIG. 7a, b) for uniform operation to occur. Mathematically, this design rule relating the internal resistance of the pico-washer (R_{wash}), the wash stream resistance between subsequent pico-washers (R_{H}), and the waste stream resistance between subsequent pico-washers (R_{L}) was represented in the following equation.

$$N \frac{( {R}_{H} + {R}_{L} )}{{R}_{w a s h}} < 0.01$$

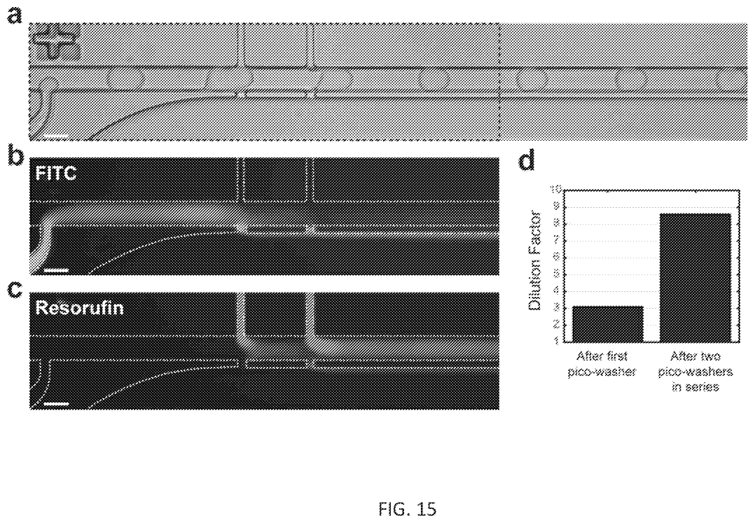

Evaluating devices with two pico-washers, as a proof-of-concept, in series with the droplet generator revealed that this design rule was critical for proper operation. When the design rule was not satisfied, two droplets in the emulsion channel could not simultaneously connect to the two pico-washers (FIG. 7c). In this case, fluidic connection between the second droplet and the second pico-washer only occurred once the droplet in the upstream pico-washer disconnected from that pico-washer (Video 10). To satisfy the design rule, we increased R_{wash} by increasing the channel length of the injection region, and decreased R_{L} and R_{H} by reducing the distance between pico-washers. When these devices were operated, two droplets simultaneously connected to the two pico-washers (FIG. 7d). Reconstructed videos of these devices confirmed the simultaneous connection and operation of the two pico-washers (Video 11). Flow resistors in this successful device were chosen such that both the electrical and fluidic resistances satisfied the design rule. Quantitative analysis from long exposure fluorescence imaging of droplets transiting the two pico-washers revealed a dilution factor of 3.1 following the first pico-washer and an overall dilution factor of 8.6 for the serial arrangement (FIG. 15).

### Incorporating Solid Particles During Pico-Washing

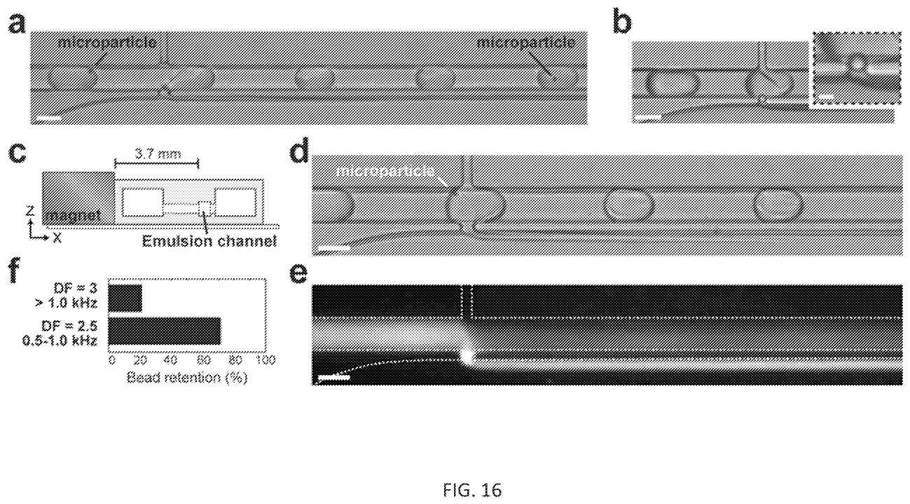

Finally, we performed experiments to provide preliminary insight into how the pico-washer performed when microparticles were encapsulated within the input droplets. In these experiments, non-magnetic, 16 μm polymethylmethacrylate (PMMA) or 8 μm paramagnetic polystyrene microparticles were added to the dispersed phase and the device was operated as previously (FIG. 16a). As before, dilution factors >3 were realized at >1.0 kHz throughputs and pico-washing was observed by visualizing the fluid transfer of dye from the dispersed phase into the waste stream (FIG. 16e). However, in experiments with 16 μm non-magnetic PMMA microparticles, the device could only operate on the order of minutes until one of the microparticles, which had a diameter larger than the width of the fluid transfer window within the pico-washer, became lodged between the emulsion channel and waste stream (FIG. 16b). Following previous work that used a magnetic force to position particles within droplets^{41,44,46,51}, we introduced a force on the microparticles to oppose the convective flow towards the waste stream during pico-washing. Experiments were performed with 8 μm paramagnetic microparticles and a 1 in.×½ in×¼ in. NdFeB permanent magnet, with a surface field of 0.4 T, placed adjacent to the PDMS device along the side opposite of the waste stream (FIG. 16c). The microparticles were readily visible using brightfield imaging (FIG. 16d) and bead retention was calculated in subsequent image analysis by quantifying the proportion of fully formed droplets containing a microparticle in the channel region after the pico-washer relative to the proportion found in the channel prior to pico-washing, analyzing at least 1000 droplets in each experiment. Bead retention was 20% when the pico-washer was operated at >1.0 kHz throughput and a dilution factor of 3. When throughput was reduced to 0.5-1.0 kHz, bead retention could be increased to 70% and achieve a dilution factor of 2.5 (FIG. 16f). The integration of micrometer scale magnets into the microchannel⁵² and optimization of device geometry could further improve these performance metrics.

### Discussion

We have demonstrated the feasibility, developed a design approach, and characterized the performance of a droplet unit operation, pico-washing, that simultaneously injects fluid into and removes fluid from droplets in flow. The fluid transfer depicted in this work results from a pressure gradient between a high-pressure wash stream and a low-pressure waste stream, with the performance of the washing process depending upon the geometry of the pico-washer. The analogous operation for just the injection of fluid into moving droplets, pico-injection, is well-established and has been used to create droplet workflows for quantitative PCR⁵³, pathogen testing in food⁵⁴ and nanoparticle crystallization⁵⁵, among others. However, processes for removing material from droplets or washing droplets are less established, and the technology created here is the first to demonstrate cross-flow through a moving droplet.

The first innovation that was required to realize pico-washing was the development of an engineering strategy for achieving stable flow of adjacent, immiscible phases. The protocol established in this study produces PDMS devices with fluid transfer channels designed to promote three-dimensional interfacial pinning, a design choice predicated on making the wetting process, and the increase in the oil-water interface that would accompany any oil entering the waste channel, less energetically favorable. This interfacial pinning also enables spatial patterning of channel hydrophilicity by successive aqueous and oil-based surface treatments, a feature required for the stable flow of each phase in the presence of the cross-droplet pressure gradient. In addition to pico-washing, the interfacial pinning and stability achieved here opens a new PDMS-based fabrication avenue for other applications that require the adjacent flow of immiscible phases, such as the creation of higher-order emulsions⁵⁶ or artificial cells⁵⁷.

Additionally, the visualization of pico-washer operation required the creation of an image processing workflow capable of quantifying the washing process with micrometer and microsecond resolution. The foundation for this workflow was the reconstruction of videos from many short-exposure images in a manner analogous to retrospective gating applied to cardiac imaging⁴⁹. In that application, a high frame rate depiction of a single heartbeat can be synthesized by labeling and sorting frames of a video sequence spanning multiple heartbeats. The workflow created here, in which images in a sequence are sorted by a reference position within each frame, expands this approach to droplet analyses and enables a high frame rate representation of droplet motion to be obtained with a relatively inexpensive and easily accessible camera. A quantitative mapping of local concentration changes during pico-washing is further obtained from such an image sequence by comparing the measured intra-droplet gray values to those from known dilutions of dye, similar to a previously used approach to map spatial changes in concentration within single phase microfluidic systems⁵⁸. When applied to droplets undergoing pico-washing, this analysis revealed that the modest washing efficiencies demonstrated by the tested architectures were limited by the retention of dye at the front of the droplet. Future work aimed at improving washing efficiency should thus be directed towards incorporating process or architectural features that promote the removal of dye from the front of the droplet.

Furthermore, an engineering design rule was devised for the successful operation of multiple pico-washers in series, a desirable feature of this unit operation that demonstrates its potential for future integration into larger microfluidic systems. This design rule conveyed the importance of minimizing the fluidic and electrical resistances between pico-washers in the wash and waste streams relative to the resistances within a pico-washer and informed design strategies such as minimizing the distance between pico-washers, increasing the cross-sectional dimensions of the wash and waste streams, and increasing the length of the channel in the injection portion of the pico-washer. When this design rule was satisfied, several pico-washers arranged in series were observed to operate on separate droplets simultaneously (FIG. 7d). The small footprint of an individual pico-washer is an advantage of this unit operation and future work should build upon this proof-of-concept demonstration with systems operating multiple pico-washers in series and in parallel. Given that silicon-based microfluidic systems readily achieve parallelized operation of 10⁴ droplet generators²⁰, it is conceivable that future parallelized arrays of pico-washers, each operating with the kHz throughput demonstrated here, could realize MHz throughputs and match the fastest droplet generation and detection systems.

The primary aim of this work was to characterize the fabrication strategy, system parameters, and design rules for a technology capable of simultaneously injecting and removing fluid from droplets at kHz throughputs. We also performed experiments to characterize pico-washer performance when solid particles were encapsulated within the droplets. In these experiments, the pico-washer performed comparably with and without solid particles, reaching dilution factors >3 at kHz throughput, though bead retention was increased at reduced throughputs and a dilution factor of 2.5. While these results provide preliminary insight into a system not optimally designed for bead retention, the improvement that was realized suggests a possible tradeoff between washing performance, throughput, and bead retention to be optimized in future work. For example, if reduced throughput of an individual pico-washer is required for optimal bead retention, designing a parallelized array of pico-washers, described above, offers an opportunity to increase the overall throughput while maintaining a sufficiently high residence time of each particle-containing droplet in the magnetic field. Furthermore, previous work demonstrated an avenue for increasing bead retention from 70% to >90% by increasing the magnetic content of the microparticles and the corresponding magnetic force exerted on these in the magnetic field⁴⁴. Similar magnetic optimization, for example by positioning the magnet closer to the emulsion channel by redesigning the channel architecture with 3D delivery vias²⁰ or integrating the fabrication of nickel iron structures into the device⁵², offers one avenue to precisely tune the magnetic force exerted on the particles during pico-washing. This optimization will be critical to achieve the >90% bead retention seen in other technologies^{44,45,51} and will be valuable for applications ranging from on-chip enzyme-linked immunosorbent assays^{8,59} to cell transfection^{37,60}. Though the experiments depicted here used magnetic microparticles, strategies involving dielectrophoresis⁴³, acoustophoresis^{38,42}, inertial focusing⁶¹, or hydrogels⁵⁹, which may facilitate fluid exchange through the solid mesh, offer alternate routes for combining pico-washing with the solid-particle-based retention of target analytes.

Taken together, this work demonstrates and characterizes a novel droplet unit operation, as well as key fabrication, quantification, and design innovations required to realize it. The pico-washer created here likely represents an early iteration of potential technology for on-demand droplet washing and one capable of functioning as a standalone device. We thus expect this work to help contribute to the continued emergence of novel droplet unit operations that will make the development of multi-step biological and chemical assays a more widespread reality.

### Materials and Methods

### Microfluidic Device Fabrication

Microfluidic devices were fabricated at The Singh Center at The University of Pennsylvania. Photomasks were designed using AutoCAD 2018 (Autodesk, Inc.) and created by writing the design files on chrome-coated soda lime photomasks (AZ1500) using a DWL 66+ mask writer (Heidelberg Instruments) with a 10 mm write head. Following exposure, the photomasks were developed in AZ 300 MIF (EMD Performance Materials Corp.) for 1.5 min, etched in Chromium Etchant 1020AC (Transene) for 2.5 min, and residual photoresist was removed via sonication for 10 minutes in Microposit Remover 1165 (Dow) at 60° C. A SUSS MicroTec MA6 Gen3 mask aligner was used to lithographically define features of SU8 (Kayaku Advanced Materials) on silicon wafers (University Wafer) to produce molds for soft lithography.

The two PDMS halves of a given device were produced by curing a 15:1 (base: crosslinker) mixture of PDMS (Sylgard 148) on different SU8 molds at 95° C. on a level hotplate. To bond the two PDMS halves together, the PDMS surfaces were first activated via oxygen plasma treatment in a barrel asher (Anatech SCE-106). Following activation, the two PDMS pieces were immediately aligned with a mask aligner (ABM 3000 HR), brought into contact, and allowed to bake on a hotplate at 100° C. for at least 10 minutes. The resulting device consisted of robustly bonded PDMS that did not exhibit leakage during device operation.

Following device construction, the waste and emulsion channels were rendered hydrophilic and hydrophobic, respectively, by successively flowing different solutions through each. First, 1% poly(vinyl alcohol) (PVA; Sigma, average molecular weight 85,000-124,000, 87-89% hydrolyzed) in Millipore water was flowed into the waste channel for 10 minutes. During this time, air was injected into the emulsion channel at 60 mL/hour to prevent the PVA solution from contaminating other channels. Following this surface treatment, air was injected into the waste channel to remove the PVA solution. Next, 0.05% trichloro (1H,1H,2H,2H-perfluorooctyl) silane (Sigma) in HFE-7500 (Oakwood Chemical) was flowed through the emulsion channel to render it hydrophobic. As before, air was injected at a rate of 60 mL/hr through the waste channel to prevent silane contamination. Following 20 minutes of silanization, the entire device was thoroughly washed with HFE-7500 and immediately used in an experiment.

### Device Operation and Imaging

A custom-built pressure-driven flow apparatus connected to compressed nitrogen was used to deliver the four fluidic input streams to the prepared devices. Two of these streams represented the dispersed and continuous phases of the emulsion: aqueous droplets were formed in a continuous phase of fluorinated oil (Biorad, QX200™ Droplet Generation Oil for EvaGreen). Input pressures for the dispersed and continuous phases were adjusted between 14-35 kPa, producing an emulsion flow rate of 2 mL/hr and a volume fraction of droplets of approximately 0.5. The input pressure of the aqueous wash stream was adjusted between 7-35 kPa and the output of this channel was closed to ensure that the wash fluid was distributed entirely to the pico-washer(s) in the microfluidic device. The input to the waste stream was adjusted between 7-21 kPa. The dispersed phase, the wash stream, and the waste stream consisted of 2×PBS (Research Products International). All input pressures were adjusted as necessary to achieve consistent operation between experiments and all flow rates were determined by collecting fluid from the desired output over a set amount of time.

The saltwater electrode was charged using a AFG3102C function generator (Tektronix) outputting a 5 Vₚₚ, 100 kHz sinusoidal signal that was amplified 20-fold by an A-301 HS high voltage amplifier (A.A. Lab Systems, Ltd.). The output from the high voltage amplifier was connected via alligator clips to the metal tubing at the input of the wash and waste streams, and verified to be 100 Vₚₚ at 100 kHz with a voltage probe. Experiments were run on the stage of a Leica DM4B Upright Research Microscope. All imaging was performed with a FLIR Grasshopper3 CMOS camera (GS3-U3-23S6C-C) and a 10×/0.30NA objective. Transmitted light images were acquired with <10 us exposures. Long exposure fluorescence images, used to quantify washing efficiency averaged over many droplets, were acquired with ˜400 ms exposures.

### Visualization and Quantification of Liquid Exchange Via Long Exposure Imaging

The degree of fluid turnover during the droplet washing process was visualized by adding two spectrally distinct fluorescence dyes to the dispersed phase and wash stream and performing long exposure fluorescence imaging. For these experiments, a solution of fluorescein isothiocyanate-dextran (FITC; Sigma, average molecular weight 10,000), diluted in 2×PBS to a final concentration of 25 μg/mL, was used as the dispersed phase. Resorufin, produced by diluting QuantaRed™ Enhanced Chemifluorescent HRP Substrate (Thermo Scientific) and Pierce™ High Sensitivity Streptavidin-HRP (Thermo Scientific) in 2×PBS, was used as the wash stream.

Washing efficiency was calculated from three long exposure images of FITC, the dye initially present in the dispersed phase: an image of the emulsion channel during pico-washing (FIG. 10a); an image of the emulsion channel without any washing (FIG. 10b); and a background image of the PDMS device away from the fluidic channels (FIG. 10c). These three images were acquired for each device. All images were aligned and the pixels corresponding to the emulsion channel were integrated over the cross-section of the channel in each image to produce three intensity profiles spanning the length of the emulsion channel (FIG. 10d): I_{wash}, corresponding to the device in operation; I_{chtl}, corresponding to the device running without an applied electric field; and I_{back}, corresponding to the background fluorescence signal. A normalized intensity profile, I(x), was then calculated according to the following formula, where x refers to the dimension that runs along the length of the emulsion channel (FIG. 10e).

$$I ( x ) = \frac{{I}_{w a s h} ( x ) - {I}_{b a c k} ( x )}{{I}_{c n t l} ( x ) - {I}_{b a c k} ( x )}$$

The normalized intensity measured at a given pixel was taken to be proportional to the fraction of time that a droplet was present at the corresponding position in the channel (p_{droplet}) and the concentration of dye that was uniformly distributed within each droplet (C_{dye}):

1˜ P_{droplet} C_{dye}

The proportion of time the droplet was present at a given position was estimated from the droplet plug length (L_{drop}) and spacing between droplets (L_{space}) (FIG. 10f).

$${p}_{droplet} ∼ \frac{{L}_{drop}}{{L}_{drop} + {L}_{space}}$$

To quantitatively describe washing from long exposure images of dye-laden droplets, the dilution factor (DF) was calculated from the following formula, where Cₚᵣₑ and Cₚₒₛₜ are the concentrations of some species in a droplet before and after washing, respectively.

$$D F = \frac{{c}_{p r e}}{{c}_{p o s t}}$$

By averaging I(x) over many pixels before ( [symbol] Iₚᵣₑ [symbol] ) and after ( [symbol] Iₚₒₛₜ [symbol] ) the washer and substituting into the previous equation, the dilution factor was calculated from quantities measured experimentally, as follows.

$$DF = \frac{〈 {I}_{p r e} 〉 \frac{{L}_{drop , post}}{{L}_{drop , post} + {L}_{space , post}}}{〈 {I}_{post} 〉 \frac{{L}_{drop , pre}}{{L}_{drop , pre} + {L}_{space , pre}}}$$

When calculating the dilution factor of two pico-washers arranged in series, the dilution factor after the first pico-washer was calculated by first averaging I (x) over all pixels between the two pico-washers. While some change in droplet volume was observed during operation, the input fluidic pressures were tuned to minimize this change during the pico-washing process.

### Droplet Video Reconstruction and Visualization of Liquid Exchange Via Short Exposure Imaging

Pico-washing was visualized with short exposure, transmitted light imaging of droplets generated with concentrated food coloring (Clover Valley) added to the dispersed phase. These images were used to construct videos of the washing process according to a custom image processing algorithm (FIG. 13). First, hundreds to thousands of images were acquired of the device in operation (FIG. 13a). Next, for each image, the position of a reference droplet was identified by either i) image segmentation via intensity-based thresholding and then determining the centroid of the object (FIG. 13b), or ii) by finding a local minimum in the sum-square difference in gray values between a reference image of a droplet and a sub-image defined at each pixel position along the length of the channel (FIG. 13c, d). In the latter, a sub-image (FIG. 13c, ii) defined for the x-th pixel in the channel was a cropped image of the channel region (FIG. 13c, i) with dimensions that matched the reference image (FIG. 13c, iii) and with the first column of gray values matching those of the x-th column in the channel image. That is, the gray value of the i-th row and j-th column of the sub-image, g, corresponded to the gray value of the i-th row and (j−1+x)-th column of the channel image, c.

$${g}_{i , j} ( x ) ∼ {c}_{i , j - 1 + x}$$

The value of the sum-square difference, E(x), was calculated for each pixel position by summing the square difference between all N pairs of gray values in the sub-image and reference image, G_{ref}.

$$E ( x ) ∼ {\sum }_{k}^{N} {( {g}_{k} ( x ) - {G}_{ref , k} )}^{2}$$

In this case, the position of a droplet was determined by finding the local minimum of E(x) (FIG. 13e). Once the position of a reference droplet within some bounds was identified for each frame, the sequence of images was reordered by these positions to produce a representation of droplet movement along the channel.

To convert the transmitted light videos of pico-washing into quantitative heat maps of intra-droplet dye dilution, the gray values in the droplet from each frame were compared to the gray values contained within droplets of known dilutions of the dye (FIG. 14). First, droplets were formed without the presence of an electric field and encapsulated with known dilutions of the food coloring dye solution used previously (FIG. 14a). Images were converted to grayscale by averaging the R-G-B values for each pixel, the images were segmented, and gray values for each intra-droplet pixel location were stored. These values were averaged on a pixel-by-pixel basis over 500 image frames for each known dye dilution to achieve a reference image depicting the average gray value at each pixel location for that dye dilution (FIG. 14b, c). These reference images enabled a linear model to be constructed for each pixel location to convert a measured gray value to a local z-averaged dye dilution, comparable to applying the Beer-Lambert Law (FIG. 14d, e). All image processing and data analysis was performed using custom scripts written in ImageJ and MATLAB 2021a (Mathworks, Inc.).

Incorporating Beads into Droplets

To evaluate device operation with solid particles encapsulated within droplets, 16 μm non-magnetic polymer microspheres (Automate Scientific Inc) and 8 μm paramagnetic iron oxide coated polystyrene microspheres (Spherotech, FCM-8052-2) were incorporated into droplets. In these experiments, the density of aqueous solution was matched to the density of the microparticles by mixing 2×PBS with OptiPrep Density Gradient Medium (Sigma-Aldrich). In the experiments with magnetic beads, a 1 in.×½ in.×¼ in. N52 NdFeB permanent magnet (K&J Magnetics, Inc. #BX084-N52) was placed adjacent to the microfluidic device and on the side opposite of the waste channel (FIG. 16c). The retention of beads in droplets was quantified by dividing the proportion of droplets containing a microparticle after pico-washing by the proportion of fully formed droplets containing a microparticle upstream of the pico-washer. At least 1000 droplets were analyzed in each experiment.

### REFERENCES

1. Macosko, E. Z. et al. Highly parallel genome-wide expression profiling of individual cells using nanoliter droplets. Cell 161, 1202-1214 (2015).
2. Klein, A. M. et al. Droplet barcoding for single-cell transcriptomics applied to embryonic stem cells. Cell 161, 1187-1201 (2015).
3. Shahi, P., Kim, S. C., Haliburton, J. R., Gartner, Z. J. & Abate, A. R. Abseq: Ultrahigh-throughput single cell protein profiling with droplet microfluidic barcoding. Sci. Rep. 7, 1-12 (2017).
4. Fu, Y. et al. Uniform and accurate single-cell sequencing based on emulsion whole-genome amplification. Proc. Natl. Acad. Sci. 112, 11923-11928 (2015).
5. Lan, F., Demaree, B., Ahmed, N. & Abate, A. R. Single-cell genome sequencing at ultra-high-throughput with microfluidic droplet barcoding. Nat. Biotechnol. 35, 640-646 (2017).
6. Prakadan, S. M., Shalek, A. K. & Weitz, D. A. Scaling by shrinking: empowering single-cell ‘omics’ with microfluidic devices. Nat. Rev. Genet. 18, 345-361 (2017).
7. Siedlik, M. J., Yang, Z., Kadam, P. S., Eberwine, J. & Issadore, D. Micro- and Nano-Devices for Studying Subcellular Biology. Small 17, 2005793 (2021).
8. Yelleswarapu, V. et al. Mobile platform for rapid sub-picogram-per-milliliter, multiplexed, digital droplet detection of proteins. Proc. Natl. Acad. Sci. U.S.A. 116, 4489-4495 (2019).
9. Ackerman, C. M. et al. Massively multiplexed nucleic acid detection with Cas13. Nature 582, 277-282 (2020).
10. Gérard, A. et al. High-throughput single-cell activity-based screening and sequencing of antibodies using droplet microfluidics. Nat. Biotechnol. 38, 715-721 (2020).
11. Bounab, Y. et al. Dynamic single-cell phenotyping of immune cells using the microfluidic platform DropMap. Nat. Protoc. 15, 2920-2955 (2020).
12. Parvez, S. et al. MIC-Drop: A platform for large-scale in vivo CRISPR screens. Science (80-.). 373, 1146-1151 (2021).
13. Scheler, O. et al. Droplet-based digital antibiotic susceptibility screen reveals single-cell clonal heteroresistance in an isogenic bacterial population. Sci. Rep. 10, 3282 (2020).
14. Agresti, J. J. et al. Ultrahigh-throughput screening in drop-based microfluidics for directed evolution. Proc. Natl. Acad. Sci. U.S.A 107, 4004-4009 (2010).
15. Fallah-Araghi, A., Baret, J. C., Ryckelynck, M. & Griffiths, A. D. A completely in vitro ultrahigh-throughput droplet-based microfluidic screening system for protein engineering and directed evolution. Lab Chip 12, 882-891 (2012).
16. Li, M. et al. A Gelatin Microdroplet Platform for High-Throughput Sorting of Hyperproducing Single-Cell-Derived Microalgal Clones. Small 14, 1803315 (2018).
17. Bawazer, L. A. et al. Combinatorial microfluidic droplet engineering for biomimetic material synthesis. Sci. Adv. 2, (2016).
18. Li, S. et al. Precision tuning of rare-earth-doped upconversion nanoparticlesviadroplet-based microfluidic screening. J. Mater. Chem. C 9, 925-933 (2021).
19. Jankowski, P., Kutaszewicz, R., Ogończyk, D. & Garstecki, P. A microfluidic platform for screening and optimization of organic reactions in droplets. J. Flow Chem. 10, 397-408 (2020).
20. Yadavali, S., Jeong, H. H., Lee, D. & Issadore, D. Silicon and glass very large scale microfluidic droplet integration for terascale generation of polymer microparticles. Nat. Commun. 9, 1-9 (2018).
21. Yang, T. et al. Reactive Gelation Synthesis of Monodisperse Polymeric Capsules Using Droplet-Based Microfluidics. Adv. Mater. Technol. 4, 1900092 (2019).
22. Chang, L. et al. Single molecule enzyme-linked immunosorbent assays: Theoretical considerations. J. Immunol. Methods 378, 102-115 (2012).
23. Abalde-Cela, S., Taladriz-Blanco, P., De Oliveira, M. G. & Abell, C. Droplet microfluidics for the highly controlled synthesis of branched gold nanoparticles. Sci. Rep. 8, 1-6 (2018).
24. Rissin, D. M. et al. Single-molecule enzyme-linked immunosorbent assay detects serum proteins at subfemtomolar concentrations. Nat. Biotechnol. 28, 595-599 (2010).
25. Cohen, L. et al. Single Molecule Protein Detection with Attomolar Sensitivity Using Droplet Digital Enzyme-Linked Immunosorbent Assay. ACS Nano 14, 9491-9501 (2020).
26. Matuła, K., Rivello, F. & Huck, W. T. S. Single-Cell Analysis Using Droplet Microfluidics. Adv. Biosyst. 4, 1900188 (2020).
27. Habib, N. et al. Massively parallel single-nucleus RNA-seq with DroNc-seq. Nat. Methods 14, 955-958 (2017).
28. Ko, J. et al. Single Extracellular Vesicle Protein Analysis Using Immuno-Droplet Digital Polymerase Chain Reaction Amplification. Adv. Biosyst. 4, 1900307 (2020).
29. Ko, J., Wang, Y., Sheng, K., Weitz, D. A. & Weissleder, R. Sequencing-Based Protein Analysis of Single Extracellular Vesicles. ACS Nano 15, 5631-5638 (2021).
30. Chaipan, C. et al. Single-Virus Droplet Microfluidics for High-Throughput Screening of Neutralizing Epitopes on HIV Particles. Cell Chem. Biol. 24, 751-757.e3 (2017).
31. Hindson, C. M. et al. Absolute quantification by droplet digital PCR versus analog real-time PCR. Nat. Methods 10, 1003-1005 (2013).
32. Lan, F., Haliburton, J. R., Yuan, A. & Abate, A. R. Droplet barcoding for massively parallel single-molecule deep sequencing. Nat. Commun. 7, 11784 (2016).
33. Shim, J. U. et al. Ultrarapid generation of femtoliter microfluidic droplets for single-molecule-counting immunoassays. ACS Nano 7, 5955-5964 (2013).
34. Kaminski, T. S. & Garstecki, P. Controlled droplet microfluidic systems for multistep chemical and biological assays. Chem. Soc. Rev. 46, 6210-6226 (2017).
35. Suea-Ngam, A., Howes, P. D., Srisa-Art, M. & Demello, A. J. Droplet microfluidics: From proof-of-concept to real-world utility? Chem. Commun. 55, 9895-9903 (2019).
36. Mazutis, L. et al. Single-cell analysis and sorting using droplet-based microfluidics. Nat. Protoc. 8, 870-891 (2013).
37. Vitor, M. T., Sart, S., Barizien, A., Torre, L. G. D. La & Baroud, C. N. Tracking the Evolution of Transiently Transfected Individual Cells in a Microfluidic Platform. Sci. Rep. 8, 1225 (2018).
38. Liu, Z., Fornell, A., Barbe, L., Hjort, K. & Tenje, M. On-chip background dilution in droplets with high particle recovery using acoustophoresis. Biomicrofluidics 13, (2019).
39. Abate, A. R., Hung, T., Marya, P., Agresti, J. J. & Weitz, D. A. High-throughput injection with microfluidics using picoinjectors using picoinjectors. Proc. Natl. Acad. Sci. U.S.A 107, 19163-19166 (2010).
40. Mary, P., Chen, A., Chen, I., Abate, A. R. & Weitz, D. A. On-chip background noise reduction for cell-based assays in droplets. Lab Chip 11, 2066-2070 (2011).
41. Verbruggen, B., Leirs, K., Puers, R. & Lammertyn, J. Selective DNA extraction with microparticles in segmented flow. Microfluid. Nanofluidics 18, 293-303 (2014).
42. Park, J., Destgeer, G., Kim, H., Cho, Y. & Sung, H. J. In-droplet microparticle washing and enrichment using surface acoustic wave-driven acoustic radiation force. Lab Chip 18, 2936-2945 (2018).
43. Huang, C., Zhang, H., Han, S.-I. & Han, A. Cell Washing and Solution Exchange in Droplet Microfluidic Systems. Anal. Chem. 93, 8622-8630 (2021).
44. Stephenson, W. High-throughput magnetic particle washing in nanoliter droplets using serial injection and splitting. Micro Nano Syst. Lett. 6, 3 (2018).
45. Doonan, S. R., Lin, M. & Bailey, R. C. Droplet CAR-Wash: Continuous picoliter-scale immunocapture and washing. Lab Chip 19, 1589-1598 (2019).
46. Lee, H., Xu, L. & Oh, K. W. Droplet-based microfluidic washing module for magnetic particle-based assays. Biomicrofluidics 8, 044113 (2014).
47. Berthier, J. et al. On the pinning of interfaces on micropillar edges. J. Colloid Interface Sci. 338, 296-303 (2009).
48. Sciambi, A. & Abate, A. R. Generating electric fields in PDMS microfluidic devices with salt water electrodes. Lab Chip 14, 2605-2609 (2014).
49. Taylor, J. M. Optically gated beating-heart imaging. Front. Physiol. 5, 481 (2014).
50. Romanowsky, M. B., Abate, A. R., Rotem, A., Holtze, C. & Weitz, D. A. High throughput production of single core double emulsions in a parallelized microfluidic device. Lab Chip 12, 802 (2012).
51. Doonan, S. R. & Bailey, R. C. K-Channel: A Multifunctional Architecture for Dynamically Reconfigurable Sample Processing in Droplet Microfluidics. Anal. Chem. 89, 4091-4099 (2017).
52. Yassine, O. et al. Isolation of cells for selective treatment and analysis using a magnetic microfluidic chip. Biomicrofluidics 8, 034114 (2014).
53. Eastburn, D. J., Sciambi, A. & Abate, A. R. Picoinjection Enables Digital Detection of RNA with Droplet RT-PCR. PLOS One 8, e62961 (2013).
54. Yuan, H. et al. Picoinjection-Enabled Multitarget Loop-Mediated Isothermal Amplification for Detection of Foodborne Pathogens. Anal. Chem. 90, 13173-13177 (2018).
55. Li, S., Zeng, M., Gaule, T., McPherson, M. J. & Meldrum, F. C. Passive Picoinjection Enables Controlled Crystallization in a Droplet Microfluidic Device. Small 13, 1702154 (2017).
56. Li, S. et al. Rapid preparation of highly reliable PDMS double emulsion microfluidic devices. RSC Adv. 6, 25927-25933 (2016).
57. Martino, C. & DeMello, A. J. Droplet-based microfluidics for artificial cell generation: a brief review. Interface Focus 6, 20160011 (2016).
58. Werts, M. H. V. et al. Quantitative full-colour transmitted light microscopy and dyes for concentration mapping and measurement of diffusion coefficients in microfluidic architectures. Lab Chip 12, 808 (2012).
59. Wang, Y. et al. Counting of enzymatically amplified affinity reactions in hydrogel particle-templated drops. Lab Chip 21, 3438-3448 (2021).
60. Li, X., Aghaamoo, M., Liu, S., Lee, D.-H. & Lee, A. P. Lipoplex-Mediated Single-Cell Transfection via Droplet Microfluidics. Small 14, 1802055 (2018).
61. Di Carlo, D., Irimia, D., Tompkins, R. G. & Toner, M. Continuous inertial focusing, ordering, and separation of particles in microchannels. Proc. Natl. Acad. Sci. U.S.A 104, 18892-7 (2007).

### Aspects

The following Aspects are illustrative only and do not limit the scope of the present disclosure or the appended claims. Any part or parts of any one or more Aspects can be combined with any part or parts of any one or more other Aspects.

Aspect 1. A fluidic system, comprising: a picowasher, the picowasher comprising:
a primary channel,
the primary channel being configured to communicate therein a continuous phase having a droplet comprising a dispersed phase therein;
a wash channel; and
a waste channel,
the picowasher defining a junction between the primary channel, the wash channel, and the waste channel, at which junction the wash channel and the waste channel enter the waste channel opposite one another, and
the picowasher being configured to communicate a wash fluid through the wash channel to the junction such that wash fluid displaces at least some of the dispersed phase from the droplet, at least some of the wash fluid being retained within the droplet and the at least some dispersed phase being communicated to the waste channel. (As explained elsewhere herein, a primary channel can be illustrated by the emulsion channel in the attached non-limiting figures and the related description of those figures. The disclosed technology is not, however, limited to use with emulsions.)

Aspect 2. The fluidic system of Aspect 1, wherein the picowasher is configured to maintain the wash channel at a higher pressure and the waste channel at a lower pressure relative to a droplet transiting the junction and in fluid communication with the wash channel and the waste channel.

Aspect 3. The fluidic system of any one of Aspects 1-2, wherein the wash channel defines a height at the junction that is greater than a height of the primary channel at the junction. As described elsewhere herein, this can define a “step” that promotes pinning of the oil-water interface between the continuous phase and waste stream in the z-direction.

Aspect 4. The fluidic system of any one of Aspects 1-3, wherein the waste channel defines a height at the junction that is greater than a height of the primary channel at the junction.

Aspect 5. The fluidic system of any one of Aspects 1-4, wherein the wash channel defines a length between the junction and a wash stream, the wash channel placing the junction into fluid communication with the wash stream.

Aspect 6. The fluidic system of any one of Aspects 1-5, wherein the waste channel defines a length between the junction and a waste stream, the waste channel placing the junction into fluid communication with the waste stream.

Aspect 7. The fluidic system of any one of Aspects 1-6, wherein the primary channel comprises a surface that is hydrophobic relative to a surface of the waste channel. Hydrophobicity can be conferred by, e.g., silanes and the like.

Aspect 8. The fluidic system of any one of Aspects 1-6, wherein the primary channel comprises a surface that is hydrophilic relative to a surface of the waste channel. Hydrophilic character can be conferred by, e.g., polyvinyl alcohol (PVA) or other materials known to be hydrophilic.

Aspect 9. The fluidic system of any one of Aspects 1-8, the system comprising N picowashers, the system configured according to the following relationship:

$$N \frac{( {R}_{H} + {R}_{L} )}{{R}_{w a s h}} < 0.01$$

wherein R_{wash} is the fluidic resistance across the wash channel and the waste channel of a picowasher wherein R_{H} is the fluidic resistance in the wash stream between subsequent picowashers, and wherein R_{L} is the fluidic resistance in the waste stream between subsequent picowashers.

Aspect 10. The fluidic system of any one of Aspects 1-9, further comprising a voltage source configured to apply a voltage across the primary channel from the wash channel to the waste channel.

Aspect 11. The fluidic system of any one of Aspects 1-10, further comprising a droplet disposed in the primary channel, the droplet being a water-in-oil droplet.

Aspect 12. The fluidic system of any one of Aspects 1-11, further comprising a droplet disposed in the primary channel, the droplet being an oil-in-water droplet.

Aspect 13. A method, comprising operating a fluidic system of any one of Aspects 1-12 so as to communicate a wash fluid through the wash channel to the junction such that wash fluid displaces at least some of the dispersed phase from the droplet, at least some of the wash fluid being retained within the droplet and the at least some dispersed phase being communicated to the waste channel.

Aspect 14. The method of Aspect 13, wherein the operating is performed so as to displace at least some of the dispersed phase from the droplet while leaving a particle in the droplet.

Aspect 15. The method of Aspect 14, wherein the particle comprises a cell.

Aspect 16. The method of Aspect 15, where in the dispersed phase displaced from the droplet comprises contents of the cell, products of the cell, or both. In this way, one can collect secretions from a cell disposed within a microdroplet while the cell remains in the microdroplet.

Aspect 17. The method of Aspect 13, wherein the operating is performed so as to effect formation of a particle within the droplet.

Aspect 18. The method of Aspect 17, wherein the formation is effected in a layer-by-layer manner. This can be accomplished in a sequential way, in which a reagent is added, a wash step is performed, a further reagent is added, a further wash step is performed, and so on.

Aspect 19. The method of Aspect 13, wherein the operating is performed so to effect barcoding a cell within the droplet, e.g., to label an individual cell with a unique nucleic acid sequences (or other marker), termed a “barcodes,” so that the cell can then be tracked through space and/or time.

Aspect 20. A method, comprising:
communicating a microdroplet in a primary channel to a first
picowasher that comprises a first junction between the primary channel, a first wash channel, and a first waste channel, the microdroplet comprising a dispersed phase therein,
the first wash channel and first waste channel opposing one another at the junction,
communicating a wash fluid through the first wash channel to the junction such that wash fluid displaces at least some of the dispersed phase from the droplet, at least some of the wash fluid being retained within the droplet and the at least some dispersed phase being communicated to the first waste channel.

Aspect 21. The method of Aspect 20, further comprising the wash channel at a higher pressure and the waste channel at a lower pressure relative to the microdroplet at the junction.

Aspect 22. The method of any one of Aspects 20-21, wherein the microdroplet is a water-in-oil microdroplet.

Aspect 23. The method of any one of Aspects 20-21, wherein the microdroplet is an oil-in-water microdroplet.

Aspect 24. The method of any one of Aspects 20-23, (i) wherein the wash channel defines a height at the junction that is greater than a height of the primary channel at the junction, (ii) wherein the waste channel defines a height at the junction that is greater than a height of the primary channel at the junction, or both (i) and (ii).

Aspect 25. The method of any one of Aspects 20-24, further comprising communicating the droplet to a second picowasher subsequent to the first picowasher, the second picowasher operating to communicate a wash fluid through a second wash channel to the second junction such that wash fluid displaces at least some of the dispersed phase from the droplet, at least some of the wash fluid being retained within the droplet and the at least some dispersed phase being communicated to the second waste channel.

Aspect 26. The method of any one of Aspects 20-25, wherein the communicating is performed so as to displace at least some of the dispersed phase from the droplet while leaving a particle in the droplet.

Aspect 27. The method of Aspect 26, wherein the particle comprises a cell and optionally wherein the dispersed phase displaced from the droplet comprises contents of the cell, products of the cell, or both.

Aspect 28. The method of Aspect 20, wherein the method is performed so as to effect formation of a particle within the droplet.

Aspect 29. The method of Aspect 28, wherein the formation is effected in a layer-by-layer manner.

Aspect 30. The method of Aspect 20, wherein the method is performed so to effect barcoding a cell within the droplet.

1. A fluidic system, comprising:
a picowasher, the picowasher comprising:
a primary channel,
the primary channel being configured to communicate therein a continuous phase having a droplet comprising a dispersed phase therein:
a wash channel; and
a waste channel,
the picowasher defining a junction between the primary channel, the wash channel, and the waste channel, at which junction the wash channel and the waste channel enter the waste channel opposite one another, and
the picowasher being configured to communicate a wash fluid through the wash channel to the junction such that wash fluid displaces at least some of the dispersed phase from the droplet, at least some of the wash fluid being retained within the droplet and the at least some dispersed phase being communicated to the waste channel.

2. The fluidic system of claim 1, wherein the picowasher is configured to maintain the wash channel at a higher pressure and the waste channel at a lower pressure relative to a droplet transiting the junction and in fluid communication with the wash channel and the waste channel.

3. The fluidic system of claim 1, wherein (a) the wash channel defines a height at the junction that is greater than a height of the primary channel at the junction, (b) wherein the waste channel defines a height at the junction that is greater than a height of the primary channel at the junction, or both (a) and (b).

4. (canceled)

5. The fluidic system of claim 1, wherein the wash channel defines a length between the junction and a wash stream, the wash channel placing the junction into fluid communication with the wash stream.

6. The fluidic system of claim 1, wherein the waste channel defines a length between the junction and a waste stream, the waste channel placing the junction into fluid communication with the waste stream.

7. The fluidic system of claim 1, wherein the primary channel comprises a surface that is hydrophobic relative to a surface of the waste channel.

8. The fluidic system of claim 1, wherein the primary channel comprises a surface that is hydrophilic relative to a surface of the waste channel.

9. The fluidic system of claim 1, the system comprising N picowashers, the system configured according to the following relationship:
$$N \frac{( {R}_{H} + {R}_{L} )}{R \text{?}} < 0.01$$
$$\text{?} \text{indicates text missing or illegible when filed}$$
wherein R_{wash} is the fluidic resistance across the wash channel and the waste channel of a picowasher wherein R_{H} is the fluidic resistance in the wash stream between subsequent picowashers, and wherein R_{L} is the fluidic resistance in the waste stream between subsequent picowashers.

10. The fluidic system of claim 1, further comprising a voltage source configured to apply a voltage across the primary channel from the wash channel to the waste channel.

11. (canceled)

12. (canceled)

13. A method, comprising operating a fluidic system of claim 1 so as to communicate a wash fluid through the wash channel to the junction such that wash fluid displaces at least some of the dispersed phase from the droplet, at least some of the wash fluid being retained within the droplet and the at least some dispersed phase being communicated to the waste channel.

14. The method of claim 13, wherein the operating is performed so as to displace at least some of the dispersed phase from the droplet while leaving a particle in the droplet.

15. The method of claim 14, wherein the particle comprises a cell.

16. The method of claim 15, where in the dispersed phase displaced from the droplet comprises contents of the cell, products of the cell, or both.

17. The method of claim 13, wherein the operating is performed so as to effect formation of a particle within the droplet.

18. The method of claim 17, wherein the formation is effected in a layer-by-layer manner.

19. The method of claim 13, wherein the operating is performed so to effect barcoding a cell within the droplet.

20. A method, comprising:
communicating a droplet in a primary channel to a first picowasher that comprises a first junction between the primary channel, a first wash channel, and a first waste channel,
the droplet comprising a dispersed phase therein,
the first wash channel and first waste channel opposing one another at the first junction,
communicating a wash fluid through the first wash channel to the junction such that wash fluid displaces at least some of the dispersed phase from the droplet, at least some of the wash fluid being retained within the droplet and the at least some dispersed phase being communicated to the first waste channel.

21. The method of claim 20, further comprising the wash channel at a higher pressure and the waste channel at a lower pressure relative to the droplet at the junction.

22. The method of claim 20, wherein the droplet is a water-in-oil droplet.

23. The method of claim 20, wherein the droplet is an oil-in-water droplet.

24. The method of claim 20, (i) wherein the wash channel defines a height at the junction that is greater than a height of the primary channel at the junction, (ii) wherein the waste channel defines a height at the junction that is greater than a height of the primary channel at the junction, or both (i) and (ii).

25. The method of claim 20, further comprising communicating the droplet to a second picowasher subsequent to the first picowasher, the second picowasher operating to communicate a wash fluid through a second wash channel to a second junction such that wash fluid displaces at least some of the dispersed phase from the droplet, at least some of the wash fluid being retained within the droplet and the at least some dispersed phase being communicated to a second waste channel.

26. The method of claim 20, wherein the communicating is performed so as to displace at least some of the dispersed phase from the droplet while leaving a particle in the droplet.

27. The method of claim 26, wherein the particle comprises a cell and optionally wherein the dispersed phase displaced from the droplet comprises contents of the cell, products of the cell, or both.

28. The method of claim 20, wherein the method is performed so as to effect formation of a particle within the droplet.

29. The method of claim 28, wherein the formation is effected in a layer-by-layer manner.

30. The method of claim 20, wherein the method is performed so to effect barcoding a cell within the droplet.
